(19) United States
(12) Patent Application Publication
(10) Pub. No.: US 2026/0250088 A1
(43) Pub. Date: Aug. 27, 2026

(54) IMAGE FORMING APPARATUS INCLUDING TRAY HOLDING CARTRIDGE CONTAINING TONER

(71) Applicant: CANON KABUSHIKI KAISHA, Tokyo (JP)

(72) Inventor: TAKESHI SHIMBA, Kanagawa (JP)

(21) Appl. No.: 19/544,914

(22) Filed: Feb. 19, 2026

(30) Foreign Application Priority Data
Feb. 25, 2025 (JP) 2025-028238

(51) Int. Cl. B65H 1/26

(52) U.S. Cl. CPC B65H 1/266

(57) ABSTRACT

An image forming apparatus includes: a tray configured to hold a cartridge containing toner; a movement unit configured to move the tray in a range including a first position and a second position; and a control unit configured to control movement of the tray by controlling the movement unit, and, at startup of the image forming apparatus, determine whether to execute position finalizing control for setting a position of the tray to the first position or the second position, based on tray information including tray position information pertaining to the position of the tray.

### BACKGROUND

### Field of the Technology

The present disclosure relates to an image forming apparatus that forms an image on a sheet.

### Description of the Related Art

US-2024-0152091 discloses an image forming apparatus in which a toner cartridge containing toner is mounted to a rotationally-driven rotary via a tray.

In US-2024-0152091, the tray is configured to be movable between an accommodation position and a removal position. The accommodation position is a position where toner from the toner cartridge accommodated in the tray can be supplied to a developing unit. The removal position is a position where the toner cartridge held in the tray can be replaced. US-2024-0152091 discloses that the tray is moved using drive force from a drive device.

To ensure the drive device performs operations with respect to the tray correctly, it is preferable that the image forming apparatus perform operations for finalizing the position of the tray. However, the image forming apparatus cannot perform image forming operations until the operations for finalizing the position of the tray are complete.

### SUMMARY

The present disclosure provides a technique for shortening the time taken for an image forming apparatus to enter a usable state when the image forming apparatus is started up.

According to an aspect of the present disclosure, an image forming apparatus includes: a tray configured to hold a cartridge containing toner; a movement unit configured to move the tray in a range including a first position and a second position; and a control unit configured to control movement of the tray by controlling the movement unit, and, at startup of the image forming apparatus, determine whether to execute position finalizing control for setting a position of the tray to the first position or the second position, based on tray information including tray position information pertaining to the position of the tray.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view of an image forming apparatus.

FIG. 2 is a cross-sectional view of a cartridge and a developing unit.

FIGS. 3A and 3B are cross-sectional views of a rotary.

FIG. 4 is an exterior view of the rotary.

FIGS. 5A to 5C are explanatory diagrams illustrating cartridge replacement operations.

FIG. 6 is a cross-sectional view of the rotary during cartridge replacement.

FIG. 7 is a perspective view illustrating the arrangement of a tray inside a rotary.

FIG. 8 is a cross-sectional view illustrating the arrangement of the tray inside the rotary.

FIGS. 9A and 9B are perspective views illustrating a drive configuration for the tray.

FIGS. 10A and 10B are cross-sectional views illustrating the drive configuration for the tray.

FIGS. 11A and 11B are diagrams illustrating an example of a tray position detection configuration.

FIG. 11C is a diagram illustrating an output signal from a photointerrupter.

FIG. 12 is a diagram illustrating another example of the tray position detection configuration.

FIG. 13 is a diagram illustrating an example of a control configuration of the image forming apparatus.

FIG. 14 is a diagram illustrating an example of tray information.

FIG. 15 is a flowchart illustrating an example of tray information management processing.

FIG. 16 is a flowchart illustrating an example of initial processing.

FIG. 17 is a diagram illustrating an example of control content information.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Overall Configuration of Image Forming Apparatus

An image forming apparatus according to the present embodiment will be described first. Here, a color laser beam printer including four developing units will be described as an example of an image forming apparatus including a plurality of developing units.

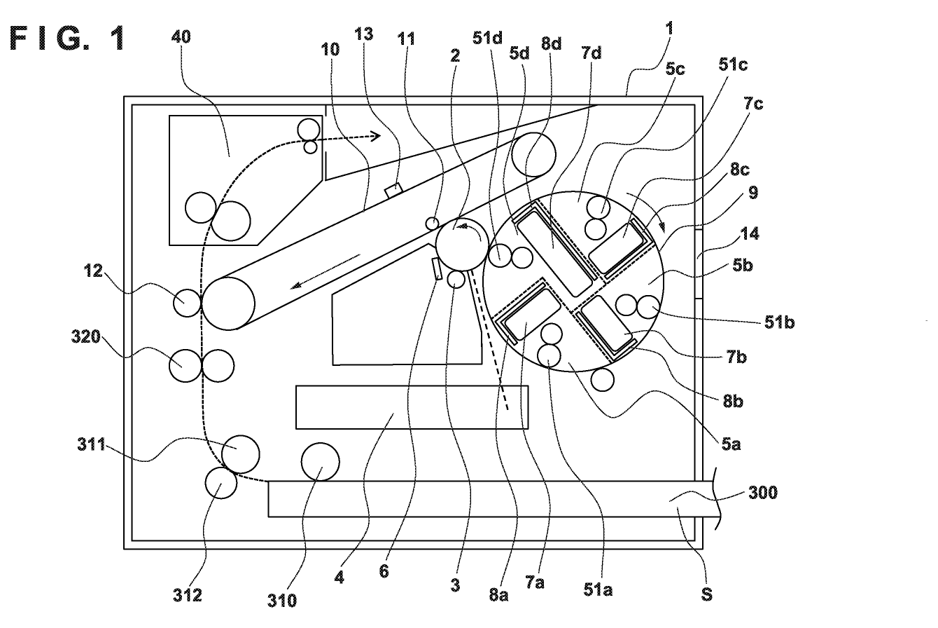

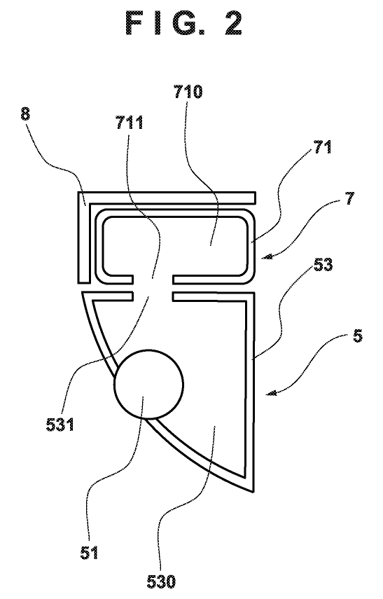

The overall configuration of the color laser beam printer and image forming operations will be described with reference to FIGS. 1 and 2. FIG. 1 is a schematic cross-sectional view of the color laser beam printer.

As illustrated in FIG. 1, an image forming apparatus main body 1 includes a drum-shaped electrophotographic photosensitive member 2 (called a “photosensitive drum 2” hereinafter). A charging roller 3, an exposure device 4, four developing units 5a to 5d, and a cleaning unit 6 are disposed in the periphery of the photosensitive drum 2. The charging roller 3 is a charging portion for uniformly charging the photosensitive drum 2. The exposure device 4 is an exposure portion that irradiates the photosensitive drum 2 with a laser beam according to image information. An electrostatic latent image is formed on the photosensitive drum 2 by irradiating the photosensitive drum 2 with a laser beam after charging. The developing units 5a to 5d are developing portions that develop the electrostatic latent image formed on the photosensitive drum 2 into a visible image using the toner of a color corresponding thereto. The cleaning unit 6 is a cleaning portion that removes toner remaining on the surface of the photosensitive drum 2.

The developing units 5a to 5d include developing rollers 51a to 51d, respectively. In addition, cartridges 7a to 7d, which contain toner serving as a coloring material, are mounted in the developing units 5a to 5d. The cartridges 7a to 7d contain yellow, magenta, cyan, and black toner, respectively. The developing units 5a to 5d develop the electrostatic latent images formed on the photosensitive drum 2 using yellow, magenta, cyan, and black toner, respectively. Here, the four developing units 5a to 5d are provided in a rotary 9, which is a rotating support member capable of rotation. The rotary 9 is also provided with trays 8a to 8d, and the cartridges 7a to 7d are held by the trays 8a to 8d, respectively, in a removable manner. As will be described later, the trays 8a to 8d are supported so as to be slidable to the outside of the rotary 9 (a mounting/removal position). The cartridges 7a to 7d are configured to be removable from the rotary 9 by sliding the trays 8a to 8d (and the cartridges 7a to 7d held by the trays 8a to 8d) to the mounting/removal position.

Note that the letter “a”, “b”, “c”, or “d” at the end of a reference sign is for distinguishing the color of the toner image formed by the member indicated by that reference sign. The letters “a”, “b”, “c”, and “d” will be omitted, and the reference signs will be applied collectively, in the following description when there is no need to distinguish the color of the toner image formed by the member in question.

FIG. 2 is a conceptual diagram illustrating a configuration for replenishing a developing unit 5 with toner from a cartridge 7. A toner frame 71 of the cartridge 7 includes a toner containment portion 710 and a discharge opening 711 that communicates with the toner containment portion 710. A developing frame 53 of the developing unit 5 includes a developing-side containment portion 530 and a receiving opening 531 that communicates with the developing-side containment portion 530. As will be described later, the discharge opening 711 opposes the receiving opening 531 when the cartridge 7 is moved to the accommodation position. When the developing unit 5 is replenished with toner from the cartridge 7, at least a part of the receiving opening 531 is positioned below at least a part of the discharge opening 711. The toner contained in the toner containment portion 710 is discharged from the discharge opening 711, and the toner discharged from the discharge opening 711 enters the developing-side containment portion 530 through the receiving opening 531. It is desirable for the cartridge 7 to have a toner-side sealing member (not shown) covering the discharge opening 711. It is also desirable for the developing unit 5 to have a developing-side sealing member (not shown) covering the receiving opening 531. Furthermore, it is desirable for the discharge opening 711 to be covered by the toner-side sealing member and the receiving opening 531 to be covered by the developing-side sealing member such that the discharge of the toner from the discharge opening 711 and the receiving opening 531 is suppressed when the cartridge 7 is not mounted in the developing unit 5.

### Image Forming Operations by Image Forming Apparatus

Image forming operations according to the present embodiment will be described next with reference to FIG. 1. First, the photosensitive drum 2 is rotated in the direction indicated by the arrow in FIG. 1 (counterclockwise) in synchronization with the rotation of an intermediate transfer belt 10. The surface of the photosensitive drum 2 is then uniformly charged by the charging roller 3. At the same time, an electrostatic latent image for a yellow toner image is formed on the photosensitive drum 2 by the exposure device 4 emitting a laser beam.

Prior to forming this electrostatic latent image, the rotary 9, which is a rotating support member capable of rotating, is rotated such that the yellow developing unit 5a is stopped at a developing position opposite the photosensitive drum 2. At the developing position, the developing roller 51a provided in the yellow developing unit 5a is in contact with the photosensitive drum 2, and the electrostatic latent image is developed using yellow toner. In other words, by rotating in the direction of the arrow indicated in FIG. 1 (clockwise) while supporting the developing units 5a to 5d, the rotary 9 moves the four supported developing units 5a to 5d one by one, in sequence, to the developing position opposite the photosensitive drum 2. The developing unit located at the developing position develops the electrostatic latent image formed on the photosensitive drum 2 in accordance with the color of the toner contained therein.

After the electrostatic latent image is developed, the yellow toner formed on the photosensitive drum 2 undergoes a primary transfer onto the intermediate transfer belt 10 by a primary transfer roller 11 disposed on an inner side of the intermediate transfer belt 10. The developing units 5a to 5d for magenta, cyan, and black are then rotationally moved in sequence by the rotation of the rotary 9, and then stop at the developing position opposite the photosensitive drum 2. The formation, development, and primary transfer of the electrostatic latent image are then performed in sequence for each of magenta, cyan, and black, in the same manner as for yellow. Four color toner images are superimposed on the intermediate transfer belt 10 as a result.

During this time, a secondary transfer roller 12 is not in contact with the intermediate transfer belt 10. Additionally, at this time, a cleaning device 13 that removes residual toner from the intermediate transfer belt 10 is also not in contact with the intermediate transfer belt 10.

Meanwhile, sheets S serving as recording media are stacked and contained in a sheet containment portion 300 provided in a lower part of the image forming apparatus main body 1. The sheets S are fed by a pickup roller 310 and separated one by one by a feed roller 311 and a separation roller 312, and then sent to a conveyance roller pair 320. The conveyance roller pair 320 sends the sheet S to a nip area between the intermediate transfer belt 10 and the secondary transfer roller 12. The four color toner images superimposed on the intermediate transfer belt 10 are transferred at once onto the surface of the sheet S that has been conveyed thereto (secondary transfer).

The sheet S onto which the toner image has been transferred is fed to a fixer 40. The sheet S is heated and pressurized in the fixer 40, and the toner image is fixed to the sheet S. A color image is formed on the sheet S as a result. The sheet S is then discharged from the fixer 40.

### Rotary Configuration

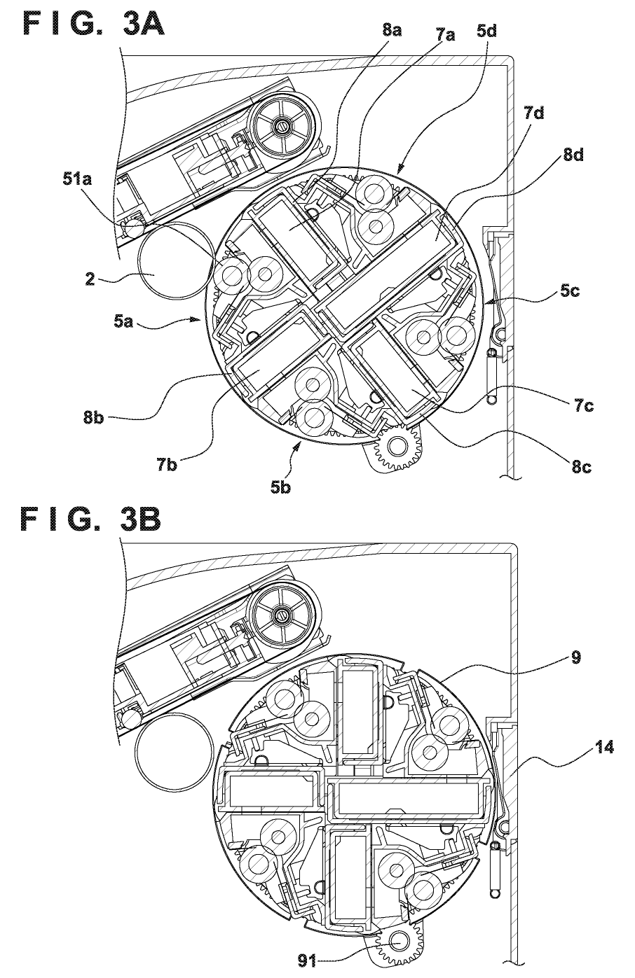

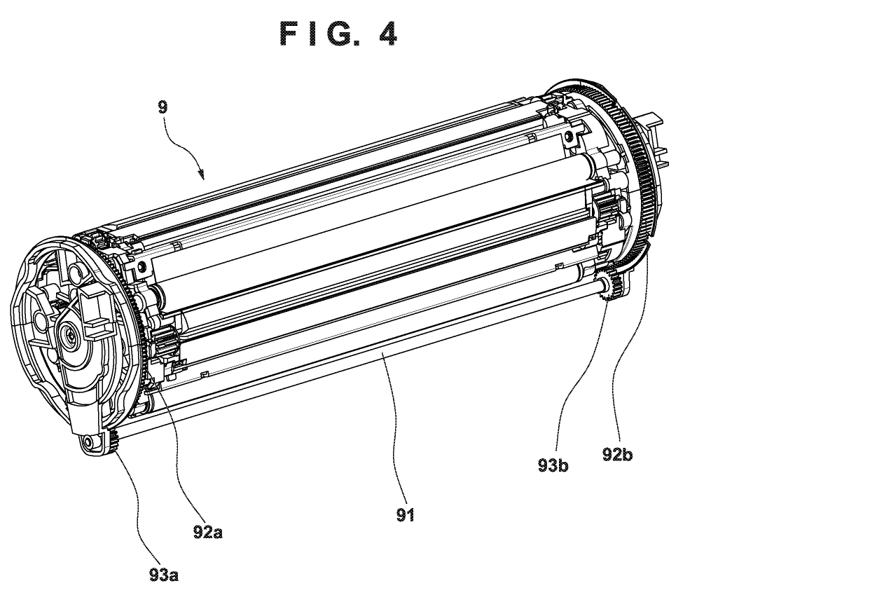

The configuration of the rotary 9 will be described with reference to FIGS. 3A, 3B, and 4. FIGS. 3A and 3B are cross-sectional views of the rotary 9. FIG. 4 is an exterior view of the rotary 9. As described earlier, the cartridge 7 is removable from the rotary 9, and a user can replace the cartridge 7 when the cartridge 7 has run out of toner. When replacing the cartridge 7, the rotary 9 is stopped at a replacement position for the cartridge 7.

FIG. 3A illustrates a cross-section of the rotary 9 when stopped at the developing position. FIG. 3B illustrates a cross-section of the rotary 9 when stopped at the replacement position. As illustrated in FIGS. 3A and 3B, the four trays 8a to 8d are disposed inside the rotary 9, and the cartridges 7a to 7d are held by the trays 8a to 8d, respectively. At this time, the cartridges 7a to 7d are mounted in the developing units 5a to 5d. In the present embodiment, the cartridge 7d containing black toner is larger than the cartridges 7a to 7c containing toner of other colors, and can hold more toner. The tray 8d holding the cartridge 7d is therefore larger than the trays 8a to 8c holding the cartridges 7a to 7c. In other words, four cartridges 7a to 7d and trays 8a to 8d of different sizes are disposed inside the rotary 9.

The rotary 9 is supported so as to be capable of pivoting about a pivot shaft 91. At the developing position, the developing roller 51 contacts the photosensitive drum 2 by being biased by a biasing member (not shown). When the rotary 9 is rotated in what is the clockwise direction in the drawings to move the cartridge 7 to the replacement position, a separating mechanism (not shown) causes the rotary 9 to pivot about the pivot shaft 91, and the developing roller 51 is separated from the photosensitive drum 2. At the replacement position, the cartridge 7 stops at a position opposite a door 14 provided in a front face of the image forming apparatus main body 1. In this state, the user can replace the cartridge 7 by sliding the tray 8 from the accommodation position in the developing unit 5 to the mounting/removal position. Operations for replacing the cartridge will be described later.

The rotational driving of the rotary 9 will be described with reference to FIG. 4. As illustrated in FIG. 4, disk gears 92a and 92b are formed at respective ends of the rotary 9. Rotary drive gears 93a and 93b are connected to respective ends of the pivot shaft 91 so as to be capable of transmitting drive force. Here, drive force from the rotary drive gears 93a and 93b is transmitted to the disk gears 92a and 92b to rotate the rotary 9.

### Cartridge Replacement Operations

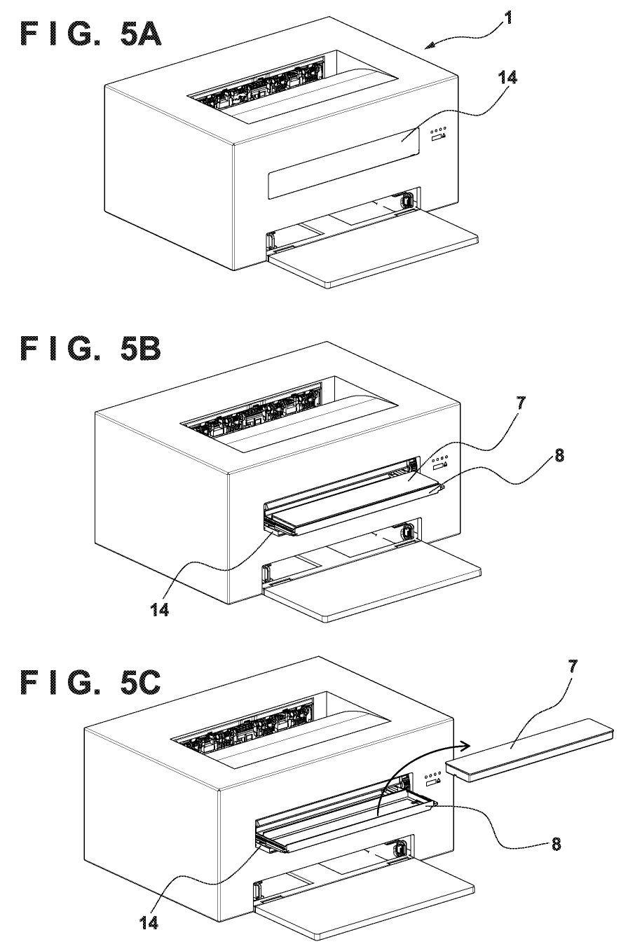

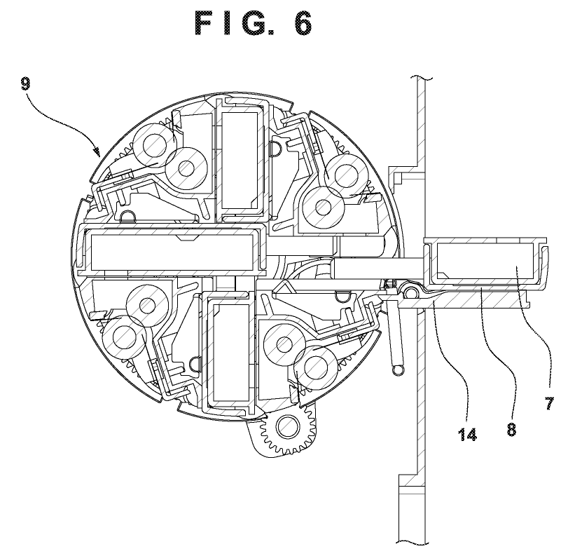

Operations by the image forming apparatus when replacing the cartridge 7 will be described with reference to FIGS. 5A, 5B, 5C, and 6. FIGS. 5A to 5C are exterior views of the image forming apparatus main body 1. FIG. 6 is a cross-sectional view of the rotary during cartridge replacement.

FIG. 5A illustrates the external appearance of the image forming apparatus main body 1 during image forming operations and when in a standby state. The door 14 is closed at this time. FIG. 5B illustrates the external appearance of the image forming apparatus main body 1 during cartridge replacement. The door 14 is open at this time, and the tray 8 and the cartridge 7 are moved to the mounting/removal position.

First, when the user makes an instruction for replacing the cartridge to the image forming apparatus main body 1 (e.g., when an operation such as pressing a “replace” button is performed), the rotary 9 rotates to the replacement position for the cartridge 7 to be replaced (the cartridge 7 that has run out of toner) and stops. The tray 8 and the cartridge 7 then slide from the accommodation position in the developing unit 5 to the mounting/removal position. The door 14 is supported so as to be capable of rotating relative to the image forming apparatus main body 1, and the door 14 is open due to the sliding movement of the tray 8 (the state illustrated in FIG. 5B). Here, because the cartridge 7 is held by the tray 8 in a removable state, the user can perform the replacement task by removing the cartridge 7 from the tray 8 and mounting a new cartridge 7, as illustrated in FIG. 5C. Note that when replacing a plurality of cartridges 7, the replacement tasks can be performed by repeating the operations described above.

FIG. 6 illustrates a cross-section of the rotary 9 during cartridge replacement. As illustrated in FIG. 6, when replacing the cartridge, it is desirable that the entire cartridge 7 protrude from the front face of the image forming apparatus main body 1 for the user to perform operations for inserting the cartridge 7 into, or removing the cartridge 7 from, the tray 8.

### Arrangement of Trays inside Rotary

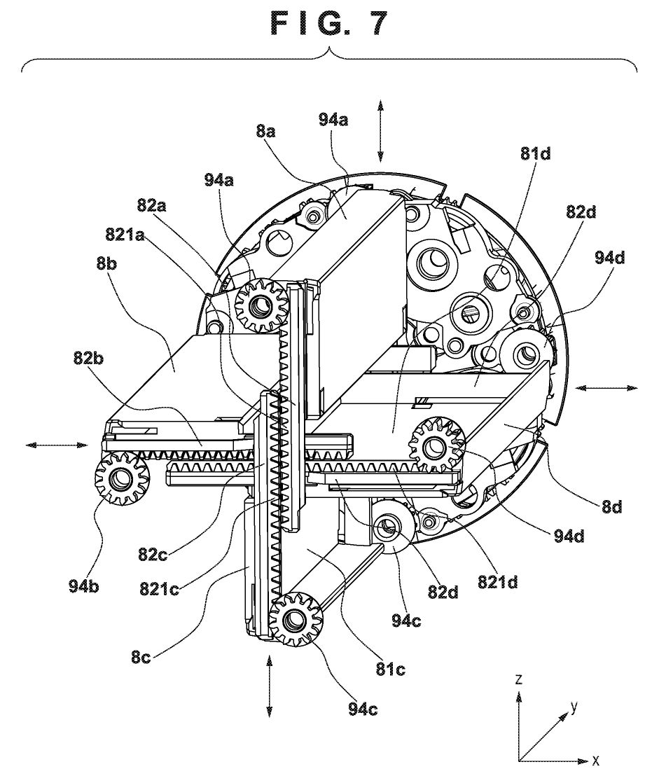

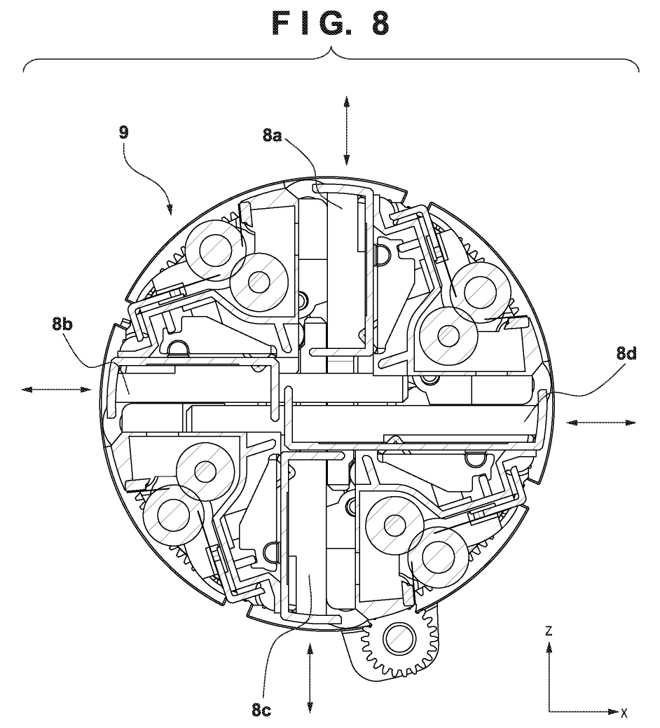

The arrangement of the trays 8a to 8d inside the rotary 9 will be described with reference to FIGS. 7 and 8. FIG. 7 is a perspective view illustrating the arrangement of the trays 8a to 8d inside the rotary 9. FIG. 8 is a cross-sectional view illustrating the arrangement of the trays 8a to 8d inside the rotary 9.

As illustrated in FIG. 7, the trays 8a to 8d are provided with cartridge holding portions 81a to 81d and tray rails 82a to 82d, respectively. The tray rails 82a to 82d are provided at respective ends between corresponding ones of the cartridge holding portions 81a to 81d. Rack portions 821a to 821d are formed in the tray rails 82a to 82d, respectively. Rack gears 94a to 94d are rotatably held inside the rotary 9, and the rack gears 94a to 94d mesh with the rack portions 821a to 821d, respectively, to enable the transmission of drive force.

As illustrated in FIGS. 7 and 8, the four trays 8a to 8d are arranged in an overlapping manner inside the rotary 9. The direction in which each tray is inserted and removed is a direction rotated 90 degrees (the directions of the arrows in the figures). Accordingly, the trays 8a and 8c are held so as to be capable of sliding in the same direction, and the trays 8b and 8d are held so as to be capable of sliding in the same direction.

### Drive Configuration for Inserting and Removing Trays

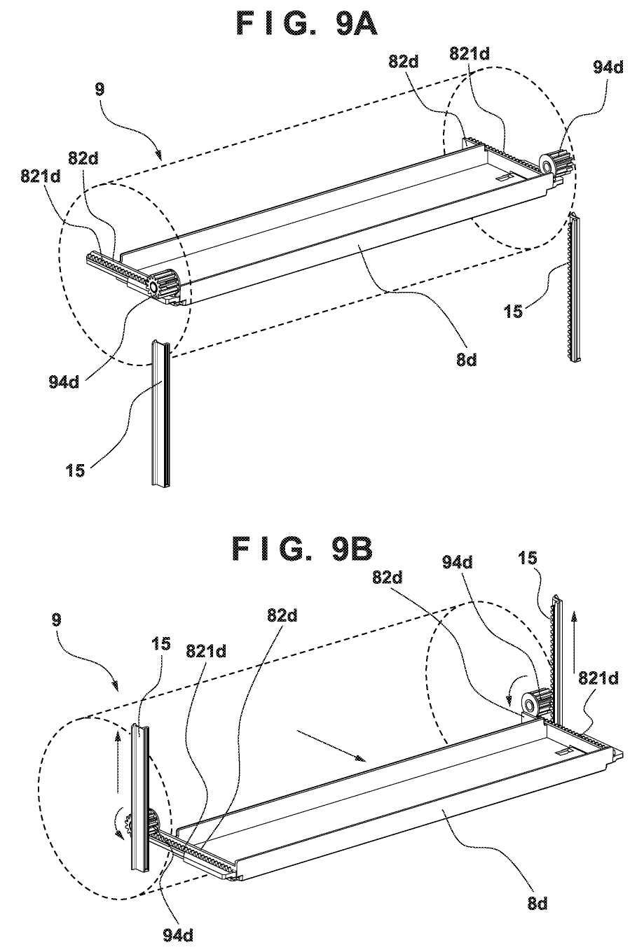

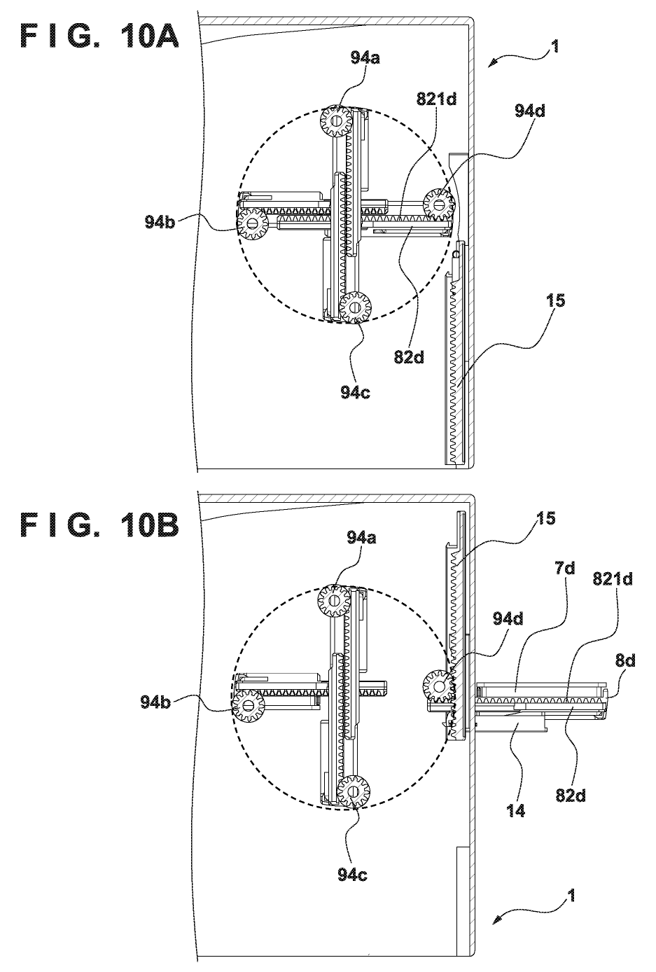

A drive configuration for the trays 8a to 8d disposed inside the rotary 9 will be described with reference to FIGS. 9A, 9B, 10A, and 10B. FIGS. 9A and 9B are perspective views illustrating the drive configuration for a tray 8. FIGS. 10A and 10B are cross-sectional views illustrating the drive configuration for a tray 8.

FIG. 9A illustrates a state in which the tray 8d is inside the rotary 9 (i.e., a state in which the cartridge 7d is mounted in the developing unit 5d). FIG. 9B illustrates the tray 8d having been slid to the mounting/removal position. As described above, two rack portions 821d are formed at respective ends. Two each of the rack gear 94d and a drive rack 15 are also disposed at positions corresponding to the rack portions 821d at the respective ends. The tray 8d is held so as to be slidable relative to the rotary 9 in a direction parallel to the tray rail 82d. The drive rack 15 is held so as to be capable of sliding vertically relative to the image forming apparatus main body 1. Although only the tray 8d among the four trays 8a to 8d is illustrated here, the drive configuration is the same for the other trays 8.

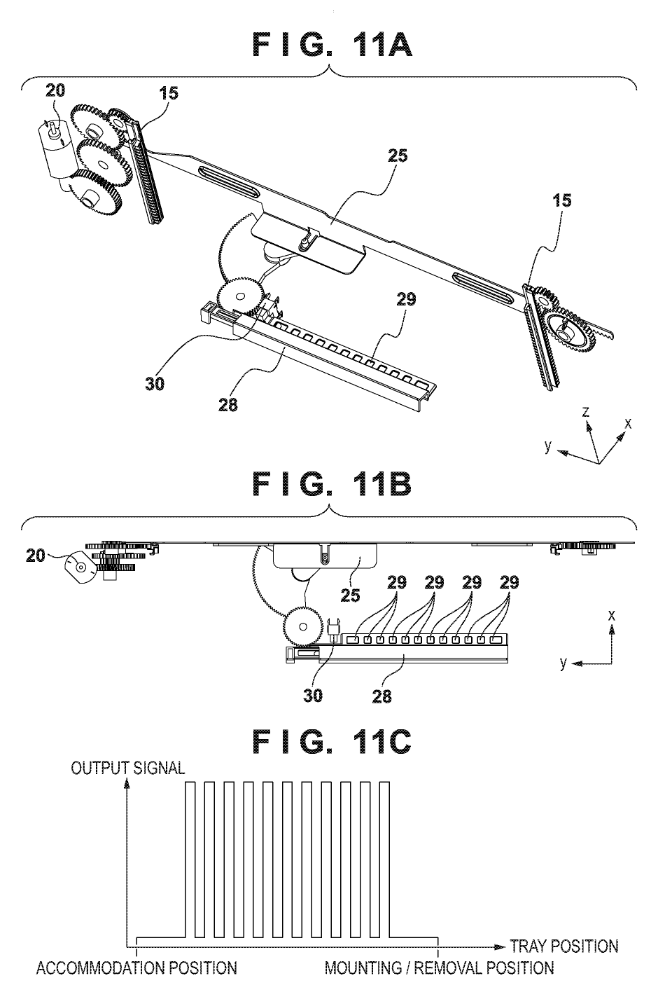

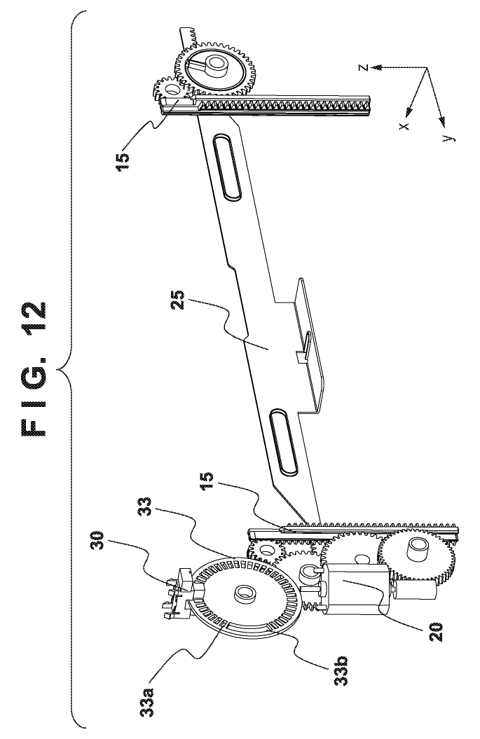

A tray insertion/removal operation of sliding the tray 8d from the interior of the rotary 9 (the accommodation position) to the exterior of the rotary 9 (the mounting/removal position) will be described with reference to FIGS. 10A and 10B. The insertion/removal operation for the tray 8d is performed by a drive source 20 (see FIGS. 11A, 11B, and 12), the drive rack 15, the rack gear 94d, and the rack portion 821d. First, drive force transmitted by the drive source 20 causes the drive rack 15 to slide in the upward direction of the image forming apparatus main body 1, which transmits drive force to the rack gear 94d. When the rack gear 94d rotates counterclockwise and transmits drive force to the rack portion 821d, the tray 8d slides toward the mounting/removal position from the accommodation position in the developing unit 5d of the cartridge 7d.

The operation of sliding the tray 8d to the interior of the rotary 9 (the accommodation position) after cartridge replacement can be performed by rotationally driving the drive source 20 in the direction opposite from that used when sliding the tray 8d outside the rotary 9 (the mounting/removal position). In this case, the drive rack 15 slides in the downward direction of the image forming apparatus main body 1, such that the tray 8d is pulled into the interior of the rotary 9.

As described above, rotationally driving the drive source 20 in the forward and reverse directions makes it possible to move the tray 8 disposed inside the rotary 9. The drive source 20 can therefore also be referred to as a movement unit that moves the tray 8. Alternatively, the drive source 20, and the drive rack 15, the rack gear 94, and the rack portion 821 that transmit the drive force of the drive source 20 to the tray 8, can also be referred to as a movement unit that moves the tray 8.

### Drive Operations by Drive Source when Moving Tray

Drive operations performed by the drive source 20 will be described with reference to FIGS. 11A, 11B, 11C, and 12. FIG. 11A is a perspective view of the area around the drive source 20, FIG. 11B is a top view of the area around the drive source 20, and FIG. 11C indicates changes in an output signal from a photointerrupter 30 as the tray 8 moves. In FIGS. 11A, 11B, and 12, a y direction is parallel to the direction of a rotation axis of a rotary main body 90. A z direction is the vertical direction. An x direction is the horizontal direction, and is a direction orthogonal to the y direction and the z direction. The movement direction of the tray 8 when moving to the mounting/removal position and the accommodation position is a direction intersecting the z direction and the y direction. In the present embodiment, the movement direction of the tray 8 is parallel to the x direction.

A slider 25 is coupled to the drive source 20. In the present embodiment, the slider 25 is coupled to the drive source 20 by at least one gear. Additionally, as illustrated in FIG. 11A, the slider 25 transmits drive force from the drive source 20 to the drive rack 15.

An encoder rack 28 is coupled to the slider 25 by a gear. A sector gear is connected to the slider 25, and a stepped gear that meshes with the sector gear and the encoder rack 28 is further provided. In FIG. 11B, when the slider 25 moves in the +y direction (to the left, in FIG. 11B), the sector gear connected at one end to the slider 25 rotates in what is the counterclockwise direction in FIG. 11B. As a result, the stepped gear rotates clockwise, and the encoder rack 28 moves in the +y direction (to the left, in FIG. 11B). This operation is performed in reverse when the slider 25 moves in the −y direction (to the right, in FIG. 11B).

As described above, the drive rack 15, the slider 25, and the encoder rack 28 are moved by the drive force from the drive source 20. Accordingly, the slider 25 and the encoder rack 28 move in conjunction with the movement of the tray 8. The slider 25 and the encoder rack 28 are examples of moving members that move in the y direction. More specifically, the slider 25 and the encoder rack 28 are examples of moving members that move linearly in the y direction.

The present embodiment is configured such that the movement amount of the encoder rack 28 is greater than the movement amount of the slider 25. In other words, the stepped gear has more teeth meshing with the encoder rack 28 than with the sector gear.

Openings 29 are provided intermittently in the encoder rack 28, and the photointerrupter 30 is disposed at a position where the openings 29 move when the encoder rack 28 moves. Circuitry (not shown) is configured such that when one of the openings 29 enters a detection position of the photointerrupter 30, the output signal switches from a low state (LOW) to a high state (HIGH), and when that opening 29 exits the detection position of the photointerrupter 30, the output signal switches from HIGH to LOW.

Accordingly, when the tray 8 starts moving from the accommodation position to the mounting/removal position, the output signal switches from LOW to HIGH; HIGH and LOW are repeatedly output while the tray 8 is moving, and when the tray 8 finishes moving to the mounting/removal position, the output signal stays constant at LOW.

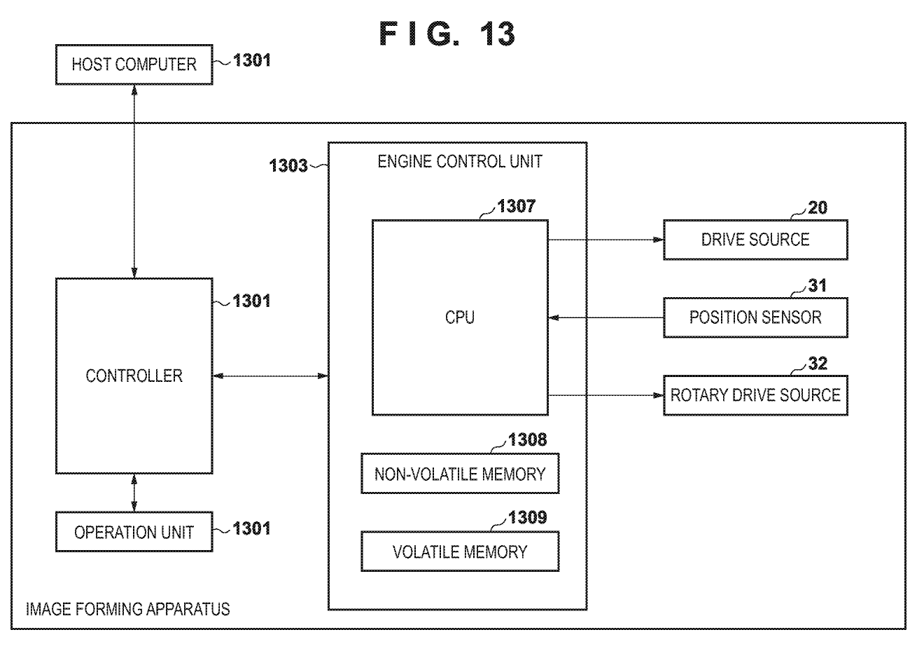

When driving the drive source 20 to start moving the tray 8 to the mounting/removal position, a central processing unit (CPU) 1307 (see FIG. 13) monitors the output signal. If the duration of the HIGH or LOW state for the output signal is less than a set period of time, the CPU 1307 determines that the tray 8 is moving, and continues to drive the drive source 20. When the output signal changes from HIGH to LOW and LOW is then output for a set period of time, the CPU 1307 determines that the tray 8 has finished moving to the mounting/removal position, and stops the driving of the drive source 20.

Likewise, when the tray 8 starts moving from the mounting/removal position to the accommodation position, the output signal switches from LOW to HIGH; HIGH and LOW are repeatedly output while the tray 8 is moving, and when the tray 8 finishes moving to the accommodation position, the output signal stays constant at low.

When driving the drive source 20 to start moving the tray 8 to the accommodation position, the CPU 1307 monitors the output signal. The drive direction of the drive source 20 when moving the tray 8 to the accommodation position is the direction opposite from the drive direction of the drive source 20 when moving the tray 8 to the mounting/removal position. If the duration of the HIGH or LOW state for the output signal is less than a set period of time, the CPU 1307 determines that the tray 8 is moving, and continues to drive the drive source 20. When the output signal changes from HIGH to LOW and LOW is then output for a set period of time, the CPU 1307 determines that the tray 8 has finished moving to the accommodation position, and stops the driving of the drive source 20.

As described above, from the drive direction of the drive source 20 and the output signal from the photointerrupter 30, the CPU 1307 can determine the movement direction of the tray 8, as well as that the tray 8 has finished moving to the accommodation position or the mounting/removal position.

The CPU 1307 can also count the number of changes in the output signal while the tray 8 is moving, i.e., the number of switches from HIGH to LOW and the number of switches from LOW to HIGH. The CPU 1307 can also determine the position of the tray 8, and whether the tray 8 has moved to the accommodation position or the mounting/removal position, by comparing the total number of changes in the output signal when moving from the mounting/removal position to the accommodation position (called a “reference number of changes” hereinafter) with the counted number of changes. The position of the tray 8 corresponds to a distance from the accommodation position or the mounting/removal position, for example.

Note that the CPU 1307 can determine that the tray 8 has stopped during movement when the output signal has stayed HIGH for at least the set period of time.

A case where the part detected by the photointerrupter 30 is formed in the encoder rack 28, which moves more than the slider 25, to improve the detection accuracy has been described here, but it is also possible to form the part detected by the photointerrupter 30 in the slider 25.

Additionally, although the output signal is described as being HIGH while the opening 29 is at the detection position of the photointerrupter 30, the configuration may be such that the output signal is LOW while the opening 29 is at the detection position of the photointerrupter 30.

Furthermore, it is also possible to form the part detected by the photointerrupter 30 in an encoder 33 coupled to the drive source 20, as illustrated in FIG. 12. FIG. 12 is a perspective view of the area around the drive source 20. The encoder 33 is coupled to the drive source 20 by a gear, and the photointerrupter 30 is disposed with the encoder 33 passing therethrough. A plurality of openings 33a and 33b are provided in the encoder 33, and at least one opening 33b is wider than the other openings 33a. The configuration is such that when the tray 8 is at the accommodation position and the mounting/removal position, the opening 33b is at a position detected by the photointerrupter 30.

By doing so, whether the tray 8 has finished moving to the accommodation position or to the mounting/removal position can be determined from the drive direction of the drive source 20 and the signal from the photointerrupter 30. Note that it is desirable that the number of rotations of the encoder during the movement of the tray 8 from the accommodation position to the mounting/removal position be no more than 1.

### Control Configuration of Image Forming Apparatus

FIG. 13 is a diagram illustrating an example of the control configuration of the image forming apparatus. A controller 1302 controls the image forming apparatus as a whole. The controller 1302 includes one or more processors and one or more memory devices, for example. The one or more memory devices may include a volatile memory and a non-volatile memory. The one or more processors control the image forming apparatus as a whole by executing control programs stored in the one or more memory devices. The one or more memory devices may also store control data used by the one or more processors to control the image forming apparatus.

The controller 1302 may be configured to be capable of communicating with a host computer 1301 outside the image forming apparatus over a network. Upon receiving a print instruction from the host computer 1301, the controller 1302 causes an engine control unit 1303 to form an image based on print data received along with the print instruction.

An operation unit 1304 includes an input interface for the user to operate the image forming apparatus, and an output interface for displaying the status of the image forming apparatus to the user. The input interface can include a pushbutton for replacing the cartridge 7, for example. The output interface can include a light-emitting diode (LED) for indicating that an anomaly has occurred during the operation for replacing the cartridge 7, for example. Note that the input interface and the output interface may be a touch panel.

For example, when the user inputs a replacement instruction for the cartridge 7 through the operation unit 1304, the controller 1302 instructs the engine control unit 1303 to move the tray 8 holding the cartridge 7 to be replaced to the mounting/removal position. As a result, the engine control unit 1303 rotates the rotary 9 to the replacement position for the cartridge 7 to be replaced, and then moves the tray 8 holding the cartridge 7 to be replaced from the accommodation position to the mounting/removal position. The controller 1302 also instructs the engine control unit 1303 to move a tray 8 which is at the mounting/removal position to the accommodation position when the user makes an input indicating that the replacement of the cartridge 7 is complete through the operation unit 1304. As a result, the engine control unit 1303 moves the tray 8 from the mounting/removal position to the accommodation position.

In the following, operations for moving the tray 8 from the accommodation position to the mounting/removal position will be referred to as “pulling out” the tray 8, and the control thereof will also be referred to as “pull-out control”. Likewise, operations for moving the tray 8 from the mounting/removal position to the accommodation position will be referred to as “pulling in” the tray 8, and the control thereof will also be referred to as “pull-in control”. The pull-out control and pull-in control of the tray 8 will be collectively referred to as “movement control”.

Note that the image forming apparatus can also be configured such that the user can operate the image forming apparatus through the host computer 1301. In this case, the host computer 1301 functions as an operation unit for the user.

The engine control unit 1303 includes the CPU 1307 having one or more processors, a non-volatile memory 1308, and a volatile memory 1309. The non-volatile memory 1308 stores control programs executed by the CPU 1307. The non-volatile memory 1308 is also used to store control data used by the CPU 1307 in the control. The volatile memory 1309 is used to store data required to be temporarily held by the CPU 1307 in the control.

Note that some or all of the processing described below as being executed by the CPU 1307 may be executed by hardware such as application-specific integrated circuits (ASICs) or programmable devices such as field programmable gate arrays (FPGAs).

Upon being instructed to form an image by the controller 1302, the CPU 1307 controls each member illustrated in FIG. 1 to form an image on a sheet S, as described with reference to FIG. 1. When the controller 1302 instructs that the tray 8 be moved to the mounting/removal position, the CPU 1307 rotates the rotary 9 and performs the pull-out control for the tray 8. Furthermore, when the controller 1302 instructs that the tray 8 be moved to the accommodation position, the CPU 1307 performs the pull-in control for the tray 8. A rotary drive source 32 illustrated in FIG. 13 is a drive source for rotating the rotary 9. The CPU 1307 controls rotation of the rotary 9 by controlling the rotary drive source 32.

As described with reference to FIGS. 11A, 11B, 11C, and 12, the CPU 1307 controls the movement of the tray 8 by controlling the drive source 20. Furthermore, as described with reference to FIGS. 11A, 11B, 11C, and 12, when controlling the movement of the tray 8, the CPU 1307 determines the position of the tray 8 based on the output signal from the photointerrupter 30. The output signal from the photointerrupter 30 indicates a detection result of detecting a plurality of openings provided in a member configured to move in conjunction with the movement of the tray 8. In the following description, the photointerrupter 30, the member in which the plurality of openings are provided, and a movement mechanism thereof will be collectively referred to as a “position sensor 31”. The position sensor 31 is also referred to as an output unit that outputs an output signal for the CPU 1307 to determine the position of the tray 8. In other words, the position sensor 31 includes the encoder rack 28 as a detection target portion that moves in conjunction with the tray 8, and the photointerrupter 30 as a sensor portion that outputs an output signal which changes in response to movement of the detection target portion. As the encoder rack 28 moves, the output signal of the photointerrupter 30 changes between HIGH and LOW. Note that the slider 25 may be used as the detection target portion, as described above.

### Tray Information

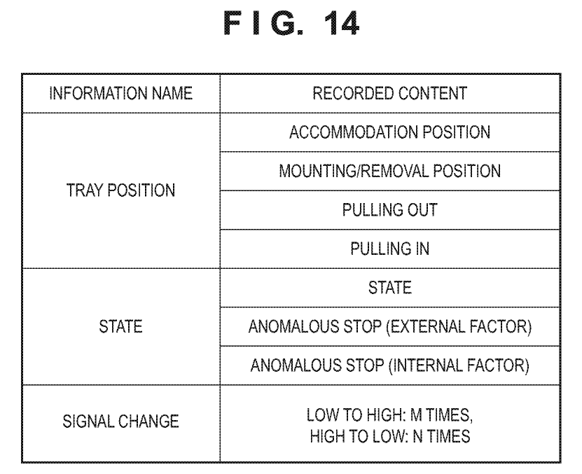

FIG. 14 illustrates an example of tray information stored in the non-volatile memory 1308 by the CPU 1307 with respect to a movement state of the tray 8. The tray information is recorded for the tray 8 in a state in which, due to a rotational state of the rotary 9, the tray 8 can be moved between the accommodation position and the mounting/removal position. The tray information can include tray position information, state information, and signal change information. The tray position information is information pertaining to the position of the tray 8, and one of “accommodation position”, “mounting/removal position”, “pulling out”, and “pulling in” is stored.

The CPU 1307 sets the tray position information to “accommodation position” upon moving the tray 8 to the accommodation position. The CPU 1307 sets the tray position information to “mounting/removal position” upon moving the tray 8 to the mounting/removal position. The CPU 1307 sets the tray position information to “pulling out” while moving the tray 8 toward the mounting/removal position through pull-out control. The CPU 1307 sets the tray position information to “pulling in” while moving the tray 8 toward the accommodation position through pull-in control. The tray position information being “pulling out” or “pulling in” indicates that the tray 8 is moving and is at a position between the accommodation position and the mounting/removal position. Furthermore, the tray position information being “pulling out” indicates that the movement direction of the tray in the movement control is a direction toward the mounting/removal position (a pull-out direction), and the tray position information being “pulling in” indicates that the movement direction of the tray in the movement control is a direction toward the accommodation position (a pull-in direction). In the following description, a position between the accommodation position and the mounting/removal position will also be referred to as an “intermediate position”. “Intermediate position” can refer to any position between the accommodation position and the mounting/removal position.

The state information is information pertaining to the state of the movement control of the tray 8, and is set to one of “normal”, “anomalous stop (external factor)”, and “anomalous stop (internal factor)”. “Normal” indicates that there is no anomaly in the movement control of the tray 8. The initial value of the state information is “normal”. “Anomalous stop (external factor)” and “anomalous stop (internal factor)” indicate that the movement control of the tray 8 has been stopped due to an anomaly in the movement control of the tray 8.

Note that “anomalous stop (internal factor)” indicates that the movement control has stopped due to a malfunction in a member in the image forming apparatus, e.g., a malfunction in the drive source 20, a malfunction in a gear that transmits the drive force from the drive source 20, a malfunction in the position sensor 31, or the like. On the other hand, “anomalous stop (external factor)” indicates that the movement control has stopped for a reason different from a malfunction in a member in the image forming apparatus, e.g., due to an operation error made by the user. As an example, “anomalous stop (external factor)” is recorded when the tray 8 cannot be moved to the mounting/removal position due to the presence of an obstacle near the door 14. As another example, “anomalous stop (external factor)” is recorded when the tray 8 cannot be moved to the accommodation position due to the user not having properly mounted the cartridge 7 in the tray 8.

The signal change information indicates the count value for the number of changes in the output signal. The number of changes includes a first number for which the output signal of the position sensor 31 has changed from LOW to HIGH, and a second number for which the output signal has changed from HIGH to LOW. The initial value of the signal change information is 0 for both the first number and the second number. The signal change information is also updated to the initial value each time the movement control finishes normally.

### Tray Information Management Processing

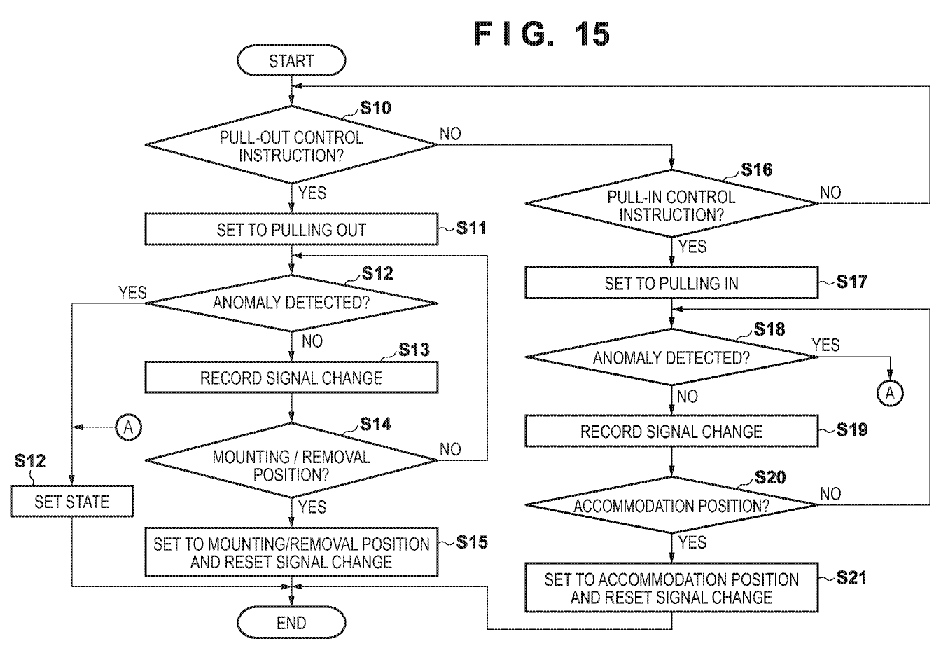

FIG. 15 is a flowchart illustrating processing executed by the CPU 1307 for managing the tray information. In step S10, the CPU 1307 determines whether the tray 8 has been instructed to move to the mounting/removal position, i.e., whether the controller 1302 has instructed pull-out control to be executed. If the execution of pull-out control has not been instructed by the controller 1302, the CPU 1307 determines, in step S16, whether the tray 8 has been instructed to move to the accommodation position, i.e., whether the controller 1302 has instructed pull-in control to be executed. If the execution of pull-in control has not been instructed by the controller 1302, the CPU 1307 repeats the processing from step S10.

If in step S10 the controller 1302 has instructed the pull-out control to be executed, in step S11, the CPU 1307 sets the tray position information to “pulling out” and starts pull-out control for the tray 8. Next, in step S12, the CPU 1307 determines whether an anomaly in the pull-out control has been detected. The CPU 1307 detects a malfunction in a member involved in the movement control, such as the drive source 20 or the position sensor 31, by any suitable method. The CPU 1307 determines that an anomaly in the pull-out control has been detected when the malfunction in the member involved in the movement control is detected. For example, upon detecting that the load of the drive source 20 has become greater than a predetermined value, the CPU 1307 may determine that an anomaly in the pull-out control has been detected. The former may correspond to an anomaly due to an internal factor, while the latter may correspond to an anomaly due to an external factor.

If an anomaly in the pull-out control has not been detected, in step S13, the CPU 1307 updates the signal change information based on the output signal from the position sensor 31. In step S14, the CPU 1307 determines whether the tray 8 has moved to the mounting/removal position based on the output signal from the position sensor 31. If the tray 8 has not moved to the mounting/removal position, the CPU 1307 repeats the processing from step S12. However, if the tray 8 has moved to the mounting/removal position, in step S15, the CPU 1307 sets the tray position information to “mounting/removal position” and resets the signal change information, whereupon the processing illustrated in FIG. 15 ends.

If in step S12 an anomaly in the pull-out control is detected, in step S22, the CPU 1307 sets the state information to “anomalous stop (external factor)” or “anomalous stop (internal factor)” and stops the pull-out control, whereupon the processing illustrated in FIG. 15 ends. The CPU 1307 also causes the anomaly in the movement control to be displayed in the operation unit 1304. Whether the state information is set to “anomalous stop (external factor)” or “anomalous stop (internal factor)” depends on the state in which the anomaly in the pull-out control is detected.

If in step S16 the execution of pull-in control has been instructed by the controller 1302, in step S17, the CPU 1307 updates the tray position information to “pulling in” and starts pull-in control of the tray 8. Next, in step S18, the CPU 1307 determines whether an anomaly in the pull-in control has been detected. The method for detecting an anomaly in the pull-in control is the same as the method for detecting an anomaly in the pull-out control.

If an anomaly in the pull-in control has not been detected, in step S19, the CPU 1307 updates the signal change information based on the output signal from the position sensor 31. In step S20, the CPU 1307 determines whether the tray 8 has moved to the accommodation position based on the output signal from the position sensor 31. If the tray 8 has not moved to the accommodation position, the CPU 1307 repeats the processing from step S18. However, if the tray 8 has moved to the accommodation position, in step S21, the CPU 1307 sets the tray position information to “accommodation position” and resets the signal change information, whereupon the processing illustrated in FIG. 15 ends. If in step S18 an anomaly in the pull-in control is detected, in step S22, the CPU 1307 updates the state information and stops the pull-in control, whereupon the processing illustrated in FIG. 15 ends.

Accordingly, when the pull-out control is successfully completed, the tray position information indicates “mounting/removal position”, the state information indicates “normal”, and the first number and the second number of the signal change information both indicate 0. Likewise, when the pull-in control is successfully completed, the tray position information indicates “accommodation position”, the state information indicates “normal”, and the first number and the second number of the signal change information both indicate 0.

On the other hand, when the pull-out control is stopped partway through, the tray position information indicates “pulling out”, the state information indicates “anomalous stop (external factor)” or “anomalous stop (internal factor)”, and the first number and the second number of the signal change information both indicate the number at the time of the stop. Likewise, when the pull-in control is stopped partway through, the tray position information indicates “pulling in”, the state information indicates “anomalous stop (external factor)” or “anomalous stop (internal factor)”, and the first number and the second number of the signal change information both indicate the number at the time of the stop.

Note that if the power of the image forming apparatus is cut (turned off) partway through pull-out control or pull-in control, the tray position information will indicate “pulling out” or “pulling in”, and the state information will indicate “normal”. The first number and the second number of the signal change information both indicate the number at the time of the stop.

As described above, the tray information is recorded for a tray 8 (referred to as a “target tray” hereinafter) in a state in which, due to the rotational state of the rotary 9, the tray 8 can be moved between the accommodation position and the mounting/removal position. Accordingly, if, due to the rotational state of the rotary 9, there is no target tray, the tray information may be deleted.

Note that the configuration can also be such that instead of managing the tray information only for the target tray, the tray information is managed individually for each of the trays 8a to 8d. In this case, for example, the tray information of a tray 8 that is not the target tray may indicate “accommodation position” as the tray position information and “normal” as the state information. The first number and the second number for the signal change information may both indicate 0. Alternatively, the tray information of a tray 8 that is not the target tray may indicate “unable to move” as the tray position information and “normal” as the state information. The first number and the second number for the signal change information may both indicate 0. Note that the CPU 1307 can determine which tray 8 is the target tray based on the rotational phase (rotational state) of the rotary 9.

### Initial Processing at Startup of Image Forming Apparatus

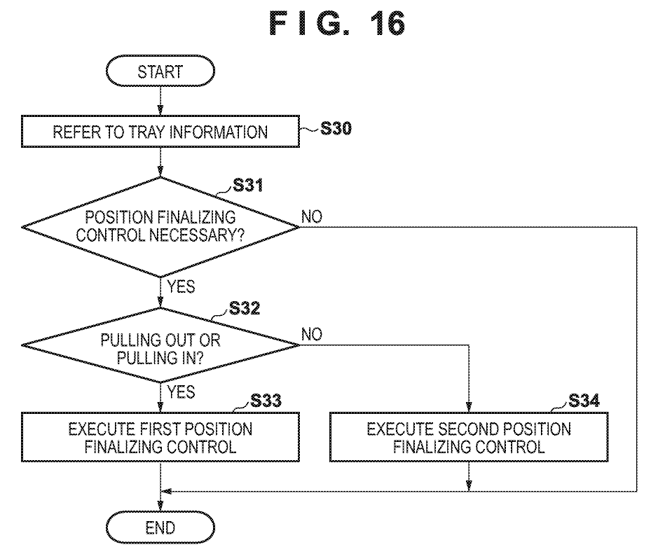

FIG. 16 is a flowchart illustrating processing executed by the CPU 1307 when the image forming apparatus is started up, i.e., when the power supply of the image forming apparatus is turned on. Starting up the image forming apparatus will simply be referred to as “startup” in the following description. The processing of FIG. 16 is executed when the target tray is present. The processing of FIG. 16 is processing for determining whether the current position of the target tray is the accommodation position or the mounting/removal position and, when the current position of the target tray cannot be determined to be the accommodation position or the mounting/removal position, moving the target tray to the accommodation position or the mounting/removal position.

In step S30, the CPU 1307 reads out the tray information of the target tray from the non-volatile memory 1308. In step S31, the CPU 1307 determines whether the current position of the target tray is the accommodation position or the mounting/removal position based on the tray information of the target tray. Specifically, if the tray position information indicates “accommodation position” or “mounting/removal position” and the state information indicates “normal”, the CPU 1307 determines that the position indicated by the tray position information is the current position of the target tray.

When the CPU 1307 determines that the current position of the target tray is the accommodation position or the mounting/removal position, in step S31, the CPU 1307 determines that position finalizing control is unnecessary, and ends the processing illustrated in FIG. 16. On the other hand, if the current position of the target tray cannot be determined to be the accommodation position or the mounting/removal position, in step S31, the CPU 1307 determines that the position finalizing control is necessary.

If the position finalizing control is determined to be necessary, in step S32, the CPU 1307 determines whether the tray position information indicates “pulling out” or “pulling in”. If the tray position information indicates “pulling out” or “pulling in”, in step S33, the CPU 1307 executes first position finalizing control. If the tray position information indicates neither “pulling out” nor “pulling in”, in step S34, the CPU 1307 executes second position finalizing control. Specifically, if the tray position information indicates “accommodation position” or “mounting/removal position” but the state information indicates “normal”, in step S34, the CPU 1307 executes the second position finalizing control. The first position finalizing control can also be processing of moving the target tray whose current position is an intermediate position to the accommodation position or the mounting/removal position and finalizing that position. The second position finalizing control can also be processing of moving the target tray whose current position is unknown to the accommodation position or the mounting/removal position and finalizing that position.

### First Position Finalizing Control

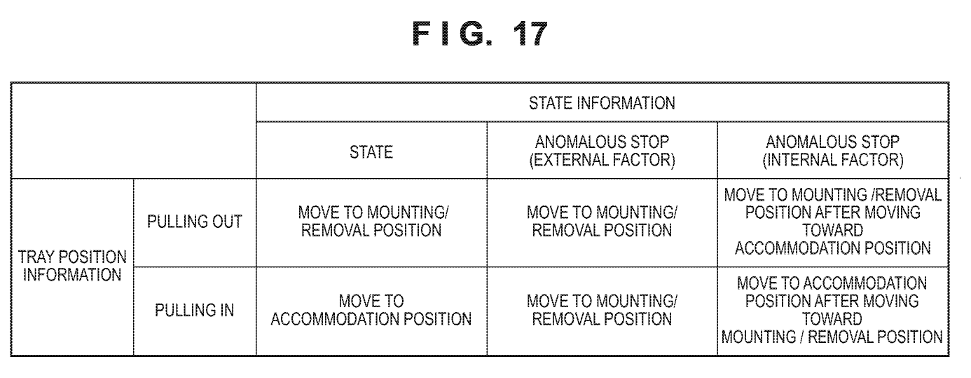

The first position finalizing control will be described first. The control content information illustrated in FIG. 17 is stored in the non-volatile memory 1308. The control content information indicates combinations of the tray position information and the state information, along with the details of the movement control performed for the target tray in the first position finalizing control.

If the image forming apparatus has been stopped during the pull-out control, the movement direction of the target tray when the image forming apparatus stopped is the pull-out direction. If the tray position information indicates “pulling out” and the state information indicates “normal”, the CPU 1307 determines that the pull-out control stopped because the power was turned off during the pull-out control. In this case, the CPU 1307 moves the target tray to the mounting/removal position. In other words, the CPU 1307 executes the pull-out control. To rephrase, when the image forming apparatus is started up, the CPU 1307 moves the target tray to the mounting/removal position by moving the target tray in the pull-out direction, which is the movement direction when the image forming apparatus stopped. Note that based on the signal change information, the CPU 1307 can determine an approximate number of switches in the output signal until the target tray reaches the mounting/removal position. In other words, the CPU 1307 can determine the timing at which the target tray will reach the mounting/removal position based on the signal change information.

Even if the tray position information indicates “pulling out” and the state information indicates “anomalous stop (external factor)”, the CPU 1307 moves the target tray to the mounting/removal position. In other words, the CPU 1307 executes the pull-out control. To rephrase, when the image forming apparatus is started up, the CPU 1307 moves the target tray to the mounting/removal position by moving the target tray in the pull-out direction, which is the movement direction when the image forming apparatus stopped. The tray position information indicating “pulling out” and the state information indicating “anomalous stop (external factor)” means that pull-out control was stopped due to an external factor before the power was turned off. The power being turned off after the pull-out control stopped, and then being turned on again, can be assumed to be the result of the user turning the power back on after eliminating an external factor which interfered with the pull-out control. It is therefore assumed that the external factor has been eliminated, and the target tray is moved to the mounting/removal position.

If the tray position information indicates “pulling out” and the state information indicates “anomalous stop (internal factor)”, the CPU 1307 first moves the target tray toward the accommodation position, and then to the mounting/removal position. In other words, the CPU 1307 executes the pull-in control before executing the pull-out control. Note that it is not necessary to move the target tray to the accommodation position in the pull-in control executed before the pull-out control. Because the anomalous stop is caused by an internal factor, it is necessary to make a repair, such as replacing a part that has malfunctioned. Accordingly, the power of the image forming apparatus is turned off for the repair, and the power of the image forming apparatus is turned back on after the repair. Because the malfunction occurred during movement toward the mounting/removal position, whether the target tray can be moved normally is determined by first moving the target tray in the reverse direction, i.e., toward the accommodation position, after which the target tray is moved to the mounting/removal position in accordance with the control from before the stop. Note that if the target tray cannot be moved normally, the movement control is stopped without changing the tray information.

If the image forming apparatus has been stopped during the pull-in control, the movement direction of the target tray when the image forming apparatus stopped is the pull-in direction. If the tray position information indicates “pulling in” and the state information indicates “normal”, the CPU 1307 determines that the pull-in control stopped because, for example, the power was turned off during the pull-in control. In this case, the CPU 1307 moves the target tray to the accommodation position. In other words, the CPU 1307 executes the pull-in control. To rephrase, when the image forming apparatus is started up, the CPU 1307 moves the target tray to the accommodation position by moving the target tray in the pull-in direction, which is the movement direction when the image forming apparatus stopped.

If the tray position information indicates “pulling in” and the state information indicates “anomalous stop (external factor)”, the CPU 1307 moves the target tray to the mounting/removal position. In other words, the CPU 1307 executes the pull-out control. To rephrase, when the image forming apparatus is started up, the CPU 1307 moves the target tray to the mounting/removal position by moving the target tray in the pull-out direction, which is an opposite direction from the movement direction when the image forming apparatus stopped. A stop caused by an external factor during pull-in control occurs mainly when a cartridge 7 of the wrong size is mounted in the target tray, or when a cartridge 7 is not mounted in the target tray correctly. The target tray is therefore moved to the mounting/removal position in order to mount the cartridge 7 in the target tray correctly.

If the tray position information indicates “pulling in” and the state information indicates “anomalous stop (internal factor)”, the CPU 1307 first moves the target tray toward the mounting/removal position, and then to the accommodation position. In other words, the CPU 1307 executes the pull-out control before executing the pull-in control. Note that it is not necessary to move the target tray to the mounting/removal position in the pull-out control executed before the pull-in control. Because the anomalous stop is caused by an internal factor, it is necessary to make a repair, such as replacing a part that has malfunctioned. Accordingly, the power of the image forming apparatus is turned off for the repair, and the power of the image forming apparatus is turned back on after the repair. Because the malfunction occurred during movement toward the accommodation position, whether the target tray can be moved normally is determined by first moving the target tray in the reverse direction, i.e., toward the mounting/removal position, after which the target tray is moved to the accommodation position in accordance with the control from before the stop. Note that if the target tray cannot be moved normally, the movement control is stopped without changing the tray information.

### Second Position Finalizing Control

The second position finalizing control will be described next. According to the flowchart in FIG. 15, if the tray position information is “accommodation position” or “mounting/removal position”, the state information should be “normal”. However, a situation can occur in which due to some anomaly, e.g., an anomaly in writing to the non-volatile memory 1308, the state information indicates “anomalous stop (external factor)” or “anomalous stop (internal factor)” despite the tray position information indicating “accommodation position” or “mounting/removal position”. In such a case, it is possible that the target tray is at an intermediate position or the mounting/removal position even though the tray position information indicates “accommodation position”. Accordingly, the details of the control cannot be finalized based on the content of the tray information, as with the first position finalizing control.

Accordingly, regardless of the content of the tray information, the CPU 1307 performs pull-out control for the target tray and monitors the output signal, for example. When the output signal changes, the CPU 1307 then performs pull-in control for the target tray and moves the target tray to the accommodation position. Note that it is not necessary to move the target tray to the mounting/removal position when the output signal changes in the first instance of the pull-out control. When the output signal is not changed by the pull-out control, the target tray is determined to actually be in the “mounting/removal position”. Accordingly, when the output signal is not changed by the pull-out control, the CPU 1307 performs the pull-in control for the target tray and monitors changes in the output signal. When the output signal changes in the pull-in control, the CPU 1307 moves the target tray to the accommodation position. Alternatively, the CPU 1307 moves the target tray to the mounting/removal position, which is the position at the time of startup. Note that when the output signal does not change in both the pull-out control and the pull-in control, the CPU 1307 makes a notification that an anomaly has occurred in the movement control.

Although the pull-out control is performed first in the foregoing example, the configuration may be such that the pull-in control is performed first instead. Furthermore, the pull-out control can be performed first when the tray position information indicates “accommodation position”, and the pull-in control can be performed first when the tray position information indicates “mounting/removal position”. When the CPU 1307 moves the target tray to the accommodation position or the mounting/removal position, the tray position information is updated according to the position to which the target tray has been moved, and the state information is updated to “normal”. If the tray position information and the state information cannot be updated, the CPU 1307 notifies the user of an anomaly in the non-volatile memory 1308.

If the tray position information is unknown, it is possible that the target tray is actually stopped at an intermediate position, but the control described above ultimately moves the target tray to the accommodation position or the mounting/removal position. As such, by executing the initial processing illustrated in FIG. 16 after startup, the position of the target tray after the initial processing is finalized as either the “accommodation position” or the “mounting/removal position”.

The configuration can also be such that only “normal” and “anomalous stop” are managed as the state information, without distinguishing between stops in the movement control due to internal factors and stops in the movement control due to external factors. In this case, the configuration may be such that the position finalizing control is not performed when, for example, the tray position information is “accommodation position” or “mounting/removal position” and the state information is “normal”. The configuration can be such that the second position finalizing control described above is performed when the tray position information is “accommodation position” or “mounting/removal position” and the state information is “anomalous stop”. Furthermore, the configuration can be such that the target tray is moved in the movement direction indicated by the tray position information, and the position of the target tray is set to the accommodation position or the mounting/removal position, when the tray position information is “pulling out” or “pulling in” and the state information is “normal”. Furthermore, the configuration can be such that the control is performed in the same manner as for an “anomalous stop (external factor)” or “anomalous stop (internal factor)”, illustrated in FIG. 17, when the tray position information is “pulling out” or “pulling in” and the state information is “anomalous stop”. When performing control for “anomalous stop (external factor)” in FIG. 17, the CPU 1307 moves the target tray to the mounting/removal position regardless of the movement direction indicated by the tray position information. Additionally, when performing control for “anomalous stop (internal factor)” in FIG. 17, the CPU 1307 moves the target tray to the mounting/removal position or the accommodation position by first moving the target tray in the direction opposite from the movement direction indicated by the tray position information, and then moving the target tray in the movement direction indicated by the tray position information.

Furthermore, the configuration can also be such that only the tray position information is managed as the tray information. In this case, the position finalizing control is not performed when the tray position information is “accommodation position” or “mounting/removal position”, and the first position finalizing control or the second position finalizing control described above is performed when the tray position information is “pulling out” or “pulling in”. When performing the first position finalizing control, the details of the control can be determined according to whether the tray position information is “pulling out” or “pulling in”. As an example, the details of the control when performing the first position finalizing control can be the same as those indicated for “normal” in FIG. 17.

The configuration can also be such that when only the tray position information is managed as the tray information, the tray position information is managed as “moving”, without distinguishing between “pulling out” and “pulling in”. In this case, the position finalizing control is not performed when the tray position information is “accommodation position” or “mounting/removal position”, and the tray is moved, for example, to a predetermined one of the accommodation position and the mounting/removal position when the tray position information is “moving”.

Note that the details of the control in the position finalizing control performed when the tray position information is “pulling out” or “pulling in” or “moving” are not limited to the examples described above, and may be other control.

The position sensor 31 of the present embodiment outputs an output signal that alternatingly indicates a first state and a second state while the tray 8 is moving between the accommodation position and the mounting/removal position, and outputs an output signal indicating the first state when the tray 8 is at the accommodation position or the mounting/removal position. Additionally, the position sensor 31 of the present embodiment outputs an output signal indicating the first state or the second state when the tray 8 is stopped at an intermediate position. Note that the first state is one of HIGH and LOW, and the second state is the other of HIGH and LOW.

Accordingly, at startup, the CPU 1307 cannot determine whether the target tray is at the accommodation position, an intermediate position, or the mounting/removal position from the output signal of the position sensor 31. Accordingly, if, when the above-described tray information is not managed, the target tray is present at startup, it is necessary for the CPU 1307 to perform the same control as the second position finalizing control described above to control the target tray to always be in the accommodation position, for example. In other words, if, when the tray information described above is not managed, the target tray is present at startup, it is necessary for the CPU 1307 to always perform the position finalizing control.

On the other hand, according to the present embodiment, by managing the tray information, the CPU 1307 may perform the position finalizing control only when necessary, which makes it possible to shorten the time taken for the image forming apparatus to enter a usable state. In the present embodiment, the position finalizing control is classified into first position finalizing control and second position finalizing control. The first position finalizing control is executed when the target tray is at an intermediate position, and is not executed when the position of the target tray is unknown, as is the case with the second position finalizing control; this makes it possible to shorten the time taken for the image forming apparatus to enter a usable state as compared to a case where the second position finalizing control is always performed.

Note that in the present embodiment, the output signal is LOW both when the target tray is at the accommodation position and in the mounting/removal position. Here, if the target tray is stopped at an intermediate position, the output signal is HIGH or LOW. Accordingly, the configuration can be such that in the processing illustrated in FIG. 16, when the tray position information indicates the accommodation position or the mounting/removal position but the output signal is HIGH, the target tray is determined to be in an intermediate position, and the first position finalizing control is performed, for example. In this case, in the first position finalizing control, the target tray may be moved to a position, among the mounting/removal position and the accommodation position, that has been determined in advance.

### Second Embodiment

A second embodiment will be described next, focusing on the differences from the first embodiment. Assume, for example, that the power of the image forming apparatus is turned off after the target tray has been moved to the mounting/removal position in response to the input of a replacement instruction for the cartridge 7. At this time, depending on the drive configuration of the tray 8, the user may be able to push the target tray toward the accommodation position by hand or the like while the power of the image forming apparatus is turned off. In such a case, because the tray position information is “mounting/removal position” and the state information is “normal” after startup, if the target tray is at the mounting/removal position, the CPU 1307 determines that the target tray is at a position different from the actual position.

Accordingly, in the present embodiment, the position sensor 31 is configured such that the output signal indicates different states when the tray 8 is at the accommodation position and when the tray 8 is at the mounting/removal position. In other words, when the tray 8 is at the accommodation position, the position sensor 31 outputs an output signal indicating the first state, and when the tray 8 is at the mounting/removal position, the position sensor 31 outputs an output signal indicating the second state. Note that in the present embodiment too, the position sensor 31 outputs an output signal that alternates between the first state and the second state while the tray 8 is moving to the accommodation position and to the mounting/removal position. Note that in the following description, the output signal indicates the first state (e.g., LOW) when the target tray is at the accommodation position, and the output signal indicates the second state (e.g., HIGH) when the target tray is at the mounting/removal position.

### Initial Processing at Startup

A flowchart illustrating the initial processing executed by the CPU 1307 at startup is basically the same as that in FIG. 16 and described in the first embodiment. However, in the first embodiment, the second position finalizing control is performed only when the tray position information indicates “accommodation position” or “mounting/removal position” but the state information does not indicate “normal”. In the present embodiment, the second position finalizing control is also performed when the tray position information indicates “accommodation position” but the output signal indicates the second state, i.e., the target tray is determined not to be in the accommodation position based on the output signal. Furthermore, the second position finalizing control is also performed when the tray position information indicates “mounting/removal position” but the output signal indicates the first state, i.e., the target tray is determined not to be in the mounting/removal position based on the output signal. Note that if the position indicated by the tray position information and the position of the target tray determined based on the output signal do not match, the second position finalizing control is executed regardless of the content of the state information. Other cases are the same as in the first embodiment.

Although the first embodiment described a form in which the state information is not managed, control can be performed even if the state information is not managed, as in the present embodiment. In other words, the configuration can be such that the second position finalizing control is executed in accordance with the state indicated by the output signal even if the tray position information is “accommodation position” or “mounting/removal position”.

Although embodiments have been described using the image forming apparatus provided with the rotary 9 in which the developing units 5a to 5d are rotationally driven, the foregoing embodiments may also be applied in an image forming apparatus that is not provided with the rotary 9. In other words, the foregoing embodiments can be applied in an image forming apparatus provided with a tray 8 holding a cartridge 7 containing toner, in which the tray 8 is configured to be movable within a range including an accommodation position and a mounting/removal position. Here, the “accommodation position” can be a position where the coloring material of the cartridge 7 can be supplied to the developing unit 5, and the “mounting/removal position” can be a position where the cartridge 7 held by the tray 8 can be replaced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-028238, filed February 25, 2025, which is hereby incorporated by reference herein in its entirety.

What is claimed is:

1. An image forming apparatus comprising:
a tray configured to hold a cartridge containing toner;
a movement unit configured to move the tray in a range including a first position and a second position; and
a control unit configured to control movement of the tray by controlling the movement unit, and, at startup of the image forming apparatus, determine whether to execute position finalizing control for setting a position of the tray to the first position or the second position, based on tray information including tray position information pertaining to the position of the tray.

2. The image forming apparatus according to claim 1, further comprising:
a non-volatile memory device,
wherein the control unit stores the tray information in the memory device.

3. The image forming apparatus according to claim 1, further comprising:
a photosensitive member; and
a developing unit configured to develop an electrostatic latent image formed on the photosensitive member,
wherein the first position is a position where the toner contained in the cartridge held by the tray can be supplied to the developing unit, and
the second position is a position where the cartridge held by the tray can be replaced.

4. The image forming apparatus according to claim 3,
wherein the developing unit is provided inside a rotary that is rotationally driven.

5. The image forming apparatus according to claim 1,
wherein the tray position information indicates that the tray is at the first position, that the tray is at the second position, or that the tray is between the first position and the second position, and
the control unit is further configured to execute the position finalizing control in a case where the tray position information at startup of the image forming apparatus indicates that the tray is between the first position and the second position.

6. The image forming apparatus according to claim 5,
wherein the tray position information further indicates a movement direction of the tray in a case where the tray position information indicates that the tray is between the first position and the second position, and
the control unit is further configured to move the tray to the first position or the second position by moving the tray in the movement direction indicated by the tray position information, in a case where the tray position information at startup of the image forming apparatus indicates that the tray is between the first position and the second position.

7. The image forming apparatus according to claim 5,
wherein the control unit is configured to move the tray to the first position or the second position by moving the tray in a movement direction of the tray at a time when the image forming apparatus was stopped, in a case where the tray position information at startup of the image forming apparatus indicates that the tray is between the first position and the second position.

8. The image forming apparatus according to claim 5,
wherein the control unit is further configured to skip executing the position finalizing control in a case where the tray position information at startup of the image forming apparatus indicates that the tray is at the first position or the second position.

9. The image forming apparatus according to claim 5,
wherein the tray information further includes state information indicating whether the movement control is stopped,
the tray position information further indicates a movement direction of the tray in a case where the tray position information indicates that the tray is between the first position and the second position, and
the control unit is further configured to control movement of the tray in the position finalizing control based on the state information and the movement direction of the tray indicated by the tray position information, in a case where the tray position information at startup of the image forming apparatus indicates that the tray is between the first position and the second position.

10. The image forming apparatus according to claim 9,
wherein the control unit is further configured to move the tray to the first position or the second position by moving the tray in the movement direction indicated by the tray position information, in a case where the tray position information at startup of the image forming apparatus indicates that the tray is between the first position and the second position and the state information does not indicate that the movement control is stopped.

11. The image forming apparatus according to claim 9,
wherein the control unit is further configured to, in a case where the tray position information at startup of the image forming apparatus indicates that the tray is between the first position and the second position and the state information indicates that the movement control is stopped, move the tray to the second position regardless of the movement direction indicated by the tray position information, or move the tray to the first position or the second position by moving the tray in a direction opposite from the movement direction indicated by the tray position information and thereafter moving the tray in the movement direction indicated by the tray position information.

12. The image forming apparatus according to claim 9,
wherein the control unit is further configured to execute the position finalizing control in a case where the tray position information at startup of the image forming apparatus indicates the first position or the second position but the state information indicates that the movement control is stopped.

13. The image forming apparatus according to claim 9,
wherein the control unit is further configured to skip executing the position finalizing control in a case where the tray position information at startup of the image forming apparatus indicates the first position or the second position and the state information does not indicate that the movement control is stopped.

14. The image forming apparatus according to claim 1, further comprising:
an output unit configured to output an output signal that alternatingly indicates a first state and a second state while the tray is moving between the first position and the second position.

15. The image forming apparatus according to claim 14,
wherein the output unit is further configured to output the output signal indicating one of the first state and the second state in a case where the tray is at the first position and in a case where the tray is at the second position, and
the control unit is further configured to determine whether the tray moved to the first position and whether the tray moved to the second position, based on the output signal.

16. The image forming apparatus according to claim 14,
wherein the tray information includes information indicating a number of times the output unit changed the output signal after a start of the movement control.

17. The image forming apparatus according to claim 14,
wherein the output unit is further configured to output the output signal indicating the first state in a case where the tray is at the first position and output the output signal indicating the second state in a case where the tray is at the second position, and
the control unit is further configured to execute the position finalizing control in a case where the tray position information at startup of the image forming apparatus indicates the first position but the output signal indicates the second state, and in a case where the tray position information indicates the second position but the output signal indicates the first state.

18. The image forming apparatus according to claim 17,
wherein the control unit is further configured to, in the position finalizing control performed in a case where the tray position information at startup of the image forming apparatus indicates the first position or the second position, perform control to move the tray toward the first position or the second position, and, if the output signal does not change, then perform control to move the tray in an opposite direction.

19. The image forming apparatus according to claim 14,
wherein the output unit includes a detection target portion configured to move in conjunction with movement of the tray, and a sensor portion configured to output the output signal that changes in accordance with movement of the detection target portion, and
a movement direction of the detection target portion is a direction that intersects with a movement direction of the tray.

20. The image forming apparatus according to claim 1,
wherein the control unit is further configured to set a value indicating that the tray is moving toward the second position in the tray position information when the movement control for moving the tray toward the second position is started, set a value indicating that the tray is at the second position in the tray position information when the tray is moved to the second position, set a value indicating that the tray is moving toward the first position in the tray position information when the movement control for moving the tray toward the first position is started, and set a value indicating that the tray is at the first position in the tray position information when the tray is moved to the first position.
